(19) United States
(12) Patent Application Publication
(10) Pub. No.: US 2025/0314754 A1
(43) Pub. Date: Oct. 9, 2025

(54) OPTICAL SENSOR

(71) Applicant: SICK AG, Waldkirch (DE)

(72) Inventors: Georg SCHNEIDER, Hamburg (DE); Jennifer ERDMANN, Witzhave (DE)

(21) Appl. No.: 19/077,589

(22) Filed: Mar. 12, 2025

(30) Foreign Application Priority Data
Apr. 9, 2024 (EP) 24169309.2

(51) Int. Cl. G01S 7/497; G01S 7/48; G01S 17/10

(52) U.S. Cl. CPC G01S 7/497; G01S 7/4808; G01S 17/10

(57) ABSTRACT

An optical sensor includes a transmission unit for emitting an optical transmission signal, a reception unit for detecting a reflected portion of the transmission signal, and a control and evaluation unit configured to receive and store a calibration data set before an operating phase. The calibration data set includes a plurality of signal threshold values that are associated with a respective background level that corresponds to a respective predetermined light intensity. The control and evaluation unit is further configured to receive operating measurement signals from the reception unit when the transmission unit is activated, to determine a current background level and to select one of the signal threshold values of the calibration data set based on the current background level, thereby being able to identify output signals derived from the operating measurement signals as invalid signals if the respective output signal is smaller than the selected signal threshold value.

The invention relates to an optical sensor comprising a transmission unit, a reception unit and a control and evaluation unit. The invention further relates to a sensor system and to a method of calibrating an optical sensor.

When evaluating measurement signals, for example of a sensor, it is generally necessary to be able to distinguish true measurement signals that represent the actual measurement variable from those signals which are caused, for example, by random events, outliers or interference, but not by the variable actually to be measured. Filter methods are known with which so-called false-positive signals are filtered out from acquired measurement signals in order to separate them from the true measurement signals that are also called true-positive signals.

With a lidar system, the distance between an object and the lidar system can, for example, be measured by determining the time of flight of laser pulses transmitted by the lidar system. To measure the time of flight, those laser pulses which are reflected at the object are acquired by means of a reception unit of the lidar system. However, such a reception unit of the lidar system is exposed to environmental conditions that, for example, comprise extraneous light, such as sunlight, that causes a certain background level or an offset in the measurement signals of the lidar system. Furthermore, the measurement signals that are emitted by the reception unit of the lidar system are generally subject to a certain noise whose intensity depends on the environmental temperature, for example.

If the known filter methods for eliminating false-positive measurement signals are applied to such a lidar system, a mean value is often formed over measurement signals that corresponds to a background level and thus includes the contribution of extraneous light, for example. A difference is then defined by which a measurement signal must be above the mean value in order to be recognized as a true measurement signal or a true-positive signal. Such a suitable difference is, for example, defined based on a predefined multiple of the standard deviation of the acquired measurement signals. Alternatively, a Mahalanobis distance can also be used as the difference from the mean value.

However, such filtering methods that use a predefined distance between a true measurement signal and a mean value are explicitly or implicitly based on the assumption that the noise of the measurement signal assumes a specific distribution, for example a Poisson distribution, a binomial distribution or a normal distribution. This assumption is either explicitly present in the modeling of the noise, or it is implicitly considered by calculating the standard deviation that assumes a normal distribution.

In practice, however, the noise of the measurement signals does not precisely follow a specific distribution. As a result, the quality of the filter method depends on the quality of the approximation to the assumed distribution. This can result in the quality of the filtering of false-positive signals being different, for example, in different environmental conditions that, for example in lidar systems, are associated with different background levels and different noise intensities. The assumption that the noise follows a specific distribution is, for example for a lidar system, fulfilled differently for different variables of the background level due to the different environmental conditions. Therefore, the so-called false-positive rate (FPR), i.e. the proportion or the probability of non-recognized false-positive measurement signals relative to the totality of the measurement signals, is not constant for different environmental conditions, for example, of a lidar system.

To ensure that a specific false-positive rate, for example of 1%, is achieved irrespective of the environmental conditions, a rather conservative or relatively largely selected difference relative to the mean value, which difference a true or true-positive measurement signal must have, is frequently used in known filter methods. Conversely, however, this can result in an unnecessarily large number of true-positive or true measurement signals being filtered out from the acquired measurement signals, in particular if the measurement signal has a rather moderate signal-to-noise ratio at a relatively high background level.

One object of the invention is to provide an optical sensor, a sensor system and a method of calibrating an optical sensor in which false-positive measurement signals are reliably recognized irrespective of the environmental conditions of the optical sensor.

This object is satisfied by an optical sensor, a sensor system and a method having the features of the independent claims. Advantageous further developments of the invention are set forth in the dependent claims, in the description and in the drawings.

The optical sensor comprises a transmission unit, a reception unit and a control and evaluation unit. The transmission unit is configured to emit an optical transmission signal into the environment of the optical sensor, whereas the reception unit is configured to detect a reflected or remitted portion of the transmission signal. The control and evaluation unit is configured to receive and store a calibration data set before an operating phase of the optical sensor. The calibration data set comprises a plurality of signal threshold values that are associated with a respective background level that corresponds to a respective predetermined light intensity.

The control and evaluation unit is further configured, during the operating phase of the optical sensor, to receive operating measurement signals from the reception unit of the optical sensor when the transmission unit is activated, to determine a current background level and to select one of the signal threshold values of the calibration data set based on the current background level. During the operating phase, the control and evaluation unit is thereby able to identify output signals that are derived from the operating measurement signals as invalid signals if the respective output signal is smaller than the selected signal threshold value.

If the optical sensor is, for example, configured as an optical scanner or laser scanner, objects can be detected in the environment of the optical sensor and their respective distances relative to the optical sensor can be determined. In this case, the transmission unit can comprise a laser that emits short pulses into the environment of the sensor.

The output signal is derived from the operating measurement signals, for example, by counting operating measurement signals that are associated with a predetermined interval for a time of flight of the transmission signal scattered back or reflected at an object until the scattered-back or reflected transmission signal reaches the reception unit. Such intervals of the time of flight can further be associated with respective intervals for distances between the optical sensor and the respective object, i.e. so-called distance bins. In this case, the output signal can comprise one count value per distance bin.

The calibration data set that is received and stored by the control and evaluation unit can be generated in a calibration phase of the optical sensor in which, for example, the transmission unit of the optical sensor is deactivated and the reception unit receives the respective predetermined light intensity. However, it is not absolutely necessary to deactivate the transmission unit during the calibration phase. The only prerequisite for creating the calibration data set is that no light of the transmission unit is incident directly or indirectly, i.e. through scattering, reflection or remission, on the reception unit. In other words, the calibration data set is created without light emitted by the transmission unit and scattered, reflected or remitted in the environment of the optical sensor being incident on the reception unit of the optical sensor. This can, for example, also be achieved by suitably covering, darkening or masking the transmission unit in the calibration phase.

The calibration data set comprises not just one signal threshold value, but rather a plurality of signal threshold values that are associated with a respective background level during operation of the optical sensor. The respective signal threshold value, based on which it is decided whether the output signal is an invalid or a valid signal, i.e. a false-positive signal or a true-positive signal, thus depends on the current or instantaneous background level during the operating phase of the optical sensor and is taken from the calibration data set.

The calibration data set can further be determined such that light intensities are defined or predetermined that correspond to or are associated with the respective background levels. The predetermined light intensities can be selected in correspondence with background levels that are to be expected or that are relevant for the operating phase in order to illuminate the reception unit with these predetermined light intensities and to determine the signal threshold values based on the signals acquired by the reception unit, for example, when the transmission unit is deactivated.

The signal threshold values ultimately serve to filter the output signal with respect to false-positive signals that are smaller than the respective signal threshold value for the current background level. Output signals identified as invalid can either be removed or marked before an output.

The current background level can either be determined based on current operating measurement signals when the transmission unit is activated by, for example, forming a mean value or median over all the distance bins or a proportion of the distance bins in which, with a high probability, no signal or echo occurs that is generated by an actual object. Alternatively, immediately after a respective measurement when the transmission unit is activated, a respective second measurement can take place when the transmission unit is deactivated in order to determine the current background level based on this second measurement. In this case, the operating measurement signals comprise both the first measurement when the transmission unit is activated and the second measurement when the transmission unit is deactivated since both measurements are performed during the operating phase of the optical sensor. In both cases, the control and evaluation unit thus determines the current background level based on operating measurement signals that are acquired during the operating phase.

The respective signal threshold values can be defined such that a defined and constant false-positive rate (FPR) is achieved independently of the respective background level or independently of the respective environmental conditions of the optical sensor. Conversely, a desired FPR, for example 1%, can thus be initially defined, based on which the respective threshold values for the predetermined light intensities or the corresponding background levels can in turn be determined. A predetermined or desired FPR can thus define the conditions for the determination of the threshold values.

The respective signal threshold values are consequently not based on assumptions regarding distributions for the noise of the calibration measurement signals. Instead, the signal threshold values are indeed dependent on the actual noise distribution, but their determination does not require any knowledge of the shape of the actual noise distribution. In other words, no model assumptions for the distribution, shape and/or time development of the calibration measurement signals are required for the determination of the signal threshold values.

In the operating phase of the optical sensor, systematic errors can therefore be avoided that can be caused by the fact that the respective false-positive rate assumes different values at different background levels if, for example, a constant multiple of the standard deviation of the operating measurement signals or of an output signal derived from the operating measurement signals is used. Instead, an output signal can be reliably identified as an invalid signal or false-positive signal, i.e. with a constant false-positive rate independently of the respective background level or independently of the environmental conditions. The reliability of the filtering of the output signals is thereby improved overall. Conversely, no unnecessary filtering out of true-positive output signals takes place since the respective signal threshold values are adapted to the respective background levels and the appropriate signal threshold value is selected that corresponds to the current background level.

According to one embodiment, the optical sensor is configured to be in communication with a calibration device during a calibration phase before the operating phase, said calibration device having an illumination unit that illuminates the reception unit with the respective predetermined light intensity to which the respective background level corresponds. The control and evaluation unit can further be configured, during the calibration phase, to detect calibration measurement signals of the reception unit for each predetermined light intensity so that a processing unit is able to generate the calibration data set based on the calibration measurement signals.

The processing unit can be part of the calibration device, but it can also be simultaneously integrated into the control and evaluation unit of the optical sensor. In this case, the processing unit is only active during the calibration phase of the optical sensor.

In the calibration phase, the calibration device for the reception unit of the optical sensor consequently simulates respective background levels and the corresponding noise, which are, for example, produced by extraneous light and other influences in respective environmental conditions during the operation of the optical sensor, by means of the illumination unit based on the predetermined light intensities. To define the predetermined light intensities, relevant background levels for the operation of the optical sensor can first be determined that, for example, depend on a planned deployment environment of the optical sensor and that can cover a possible measurement range for the optical sensor. In other words, all relevant background levels for the operation of the optical sensor can be determined first.

The predetermined light intensities for the calibration phase of the optical sensor are then defined such that they correspond to the determined relevant background levels. Due to the deactivated transmission unit of the optical sensor during the calibration phase, the calibration measurement signals only represent a respective background level for the respective predetermined light intensity and the corresponding noise, i.e. fluctuations around the respective background level.

Signals can be derived from the calibration measurement signals in a similar way to as described above for the output signals that are derived from the operating measurement signals. Specifically, calibration measurement signals that lie within a specific interval in terms of their size can be counted and the numbers can be associated with the respective so-called distance bins. The signal threshold values can be determined based on these derived signals.

A respective signal threshold value for the respective predetermined light intensity can, for example, be determined based on one or more maxima of the signals derived from the calibration measurement signals. The output signal that is derived from the operating measurement signals is only identified as a valid signal if it is greater than or equal to these maxima of the calibration measurement signals for the corresponding current background level, i.e. greater than or equal to the corresponding signal threshold value for the current background level.

According to a further embodiment, the optical sensor is configured for a time-correlated single photon counting (TCSPC). Furthermore, the control and evaluation unit can be configured to produce respective histograms of the time-correlated single photon counting (TCSPC histograms) for both the calibration measurement signals and the operating measurement signals.

An optical sensor with time-correlated single photon counting, for example, periodically transmits light pulses that are typically a few nanoseconds long and define a starting point in time of a respective measurement. During a time interval until the next light pulse, the light that is, for example, reflected or scattered back at an object in the environment of the optical sensor is detected by means of the reception unit of the optical sensor. The time interval between two light pulses that are emitted by the transmission unit can be divided into a plurality of short time sections that are, for example, 500 ps long. Each time section can be assigned a point in time that corresponds to a time interval from the starting point in time of the measurement at which a light pulse was last emitted by the transmission unit.

Depending on the distance from the object in the environment of the optical sensor, the reflected or scattered-back light pulse reaches the reception unit of the optical sensor at different points in time. In other words, the emitted light pulse has different times of flight depending on the distance of the object up to the detection in the reception unit. On the respective detection of a reflected or scattered-back light pulse, the reception unit can generate an electrical signal that can be associated with one of the time sections within the time interval between two light pulses by means of a time-to-digital converter (TDC).

If the transmission unit of the optical sensor emits a plurality of light pulses, the electrical signals or events that are generated by reflected or scattered-back light pulses in the reception unit and that are associated with a respective time section can be counted for the plurality of emitted light pulses. The counted electrical signals or events over the respective time sections form a histogram of the time-correlated single photon counting (TCSPC histogram) that can, for example, be represented by digital signals in a memory of the control and evaluation unit. Since the time sections of the TCSPC histogram are associated with different times of flight of the light pulses up to an object in the environment of the optical sensor and thus with different distances relative to the optical sensor, the time sections that divide the time interval between a respective two light pulses of the transmission unit correspond to respective distances relative to the optical sensor. The time sections are therefore also designated as so-called distance bins and, in a TCSPC histogram, numbers or count values can be shown over distance bins.

In the present embodiment of the optical sensor, however, respective TCSPC histograms are produced not only in the operating phase of the optical sensor, but also during the calibration phase by means of the calibration measurement signals, i.e. without the transmission unit of the optical sensor being actively involved in the measurement. The TCSPC histograms can also be produced during the calibration phase based on the calibration measurement signals without emitted light pulses of the transmission unit being generated since the illumination unit of the calibration device can illuminate the reception unit of the optical sensor in the calibration phase with a light intensity that is constant over time in each case and that can, for example, correspond to the extraneous light to be expected under a respective environmental condition during the operating phase.

The TCSPC histograms thus represent, for the calibration phase, the signals that are derived from the calibration measurement signals and that are used for determining the respective signal threshold values and, for the operating phase, the output signals that are derived from the operating measurement signals. However, these output signals are then compared with the respective signal threshold values in order to be identified as a valid or invalid signal. The valid output signals can also be designated as echoes since they are ultimately caused by an actual reflection or backscatter at an object.

In the calibration phase, the background component and the noise component of the respective TCSPC histograms can be simulated by means of the respective predetermined light intensity for the corresponding background level. The respective signal threshold values for the operating phase can thus be directly determined based on the TCSPC histograms of the calibration phase and can so-to-say be read off in the histograms. To define the respective signal threshold values, one or more maxima of the TCSPC histograms can, for example, be determined that are produced in the calibration phase for the respective predetermined light intensity or the corresponding background level.

The control and evaluation unit can further be configured, during the calibration phase of the optical sensor, to produce a respective plurality of TCSPC histograms for each predetermined light intensity. Furthermore, the processing unit can be configured, during the calibration device, to determine a respective maximum count value or histogram value for each of the TCSPC histograms that are associated with the respective predetermined light intensity in order to produce a statistical distribution of the maximum count values for the respective predetermined light intensity, and to determine the signal threshold values for the respective predetermined light intensities based on the statistical distribution.

Since the respective signal threshold values thus depend on the statistical distribution of the maximum count values of a plurality of histograms, the assessment of the operating measurement signals during the operating phase of the optical sensor can take place in a reliable manner since a valid signal must be greater than the respective signal threshold value and thus greater than a certain proportion of the maximum count values in the statistical distribution. Instead of a respective maximum count value, a plurality of count values can also be used that, for example, correspond to the largest, second largest, third largest, etc. count value.

The processing unit can further be configured, during the calibration phase of the optical sensor, to determine a respective cumulative relative frequency of the maximum count values for each predetermined light intensity based on the statistical distribution, and to determine the respective signal threshold values for the predetermined light intensities based on the respective cumulative relative frequency. The cumulative relative frequency can, for example, be displayed in dependence on the maximum count values and can thus represent an efficiently usable transformation of the statistical distribution.

From such a representation of the cumulative relative frequency, the respective signal threshold values can, for example, be determined as those maximum count values at which the respective cumulative relative frequency reaches a specific value, for example 99%, so that, conversely, the cumulative relative frequency for invalid output signals that are not recognized in the operating phase is only 1 minus the cumulative relative frequency at the maximum count value, for example 1%.

The processing unit can further be configured, during the calibration phase of the optical sensor, to use at least one predefined percentage for false-positive or invalid output signals in order to determine the respective signal threshold values for the associated background level based on the respective cumulative relative frequency. In such an embodiment, the false-positive rate can thus be predefined based on the predefined percentage for the false-positive output signals so that the respective signal threshold values for all the background levels correspond to the predefined false-positive rate. In other words, the respective signal threshold values can be determined based on the respective cumulative relative frequency of the maximum count values such that the proportion of the filtered false-positive output signals, which are thus recognized as invalid output signals, is constant irrespective of the associated background levels.

Furthermore, the processing unit can additionally be configured, during the calibration phase of the optical sensor, to use a plurality of predefined percentages, i.e. more than one predefined percentage, for false-positive output signals in order to determine, for each predefined percentage, a set of respective signal threshold values for the associated background level based on the respective cumulative relative frequency. For example, it can be predefined that 0.1%, 1%, 5% and 10% of the operating measurement signals may not be recognized as false-positive output signals or invalid output signals in the operating phase so that the predefined percentage for false-positive output signals to be filtered is 99.9%, 99%, 95% and 90%, respectively. Corresponding respective sets of the signal threshold values can then be determined according to the respective associated background level based on the respective cumulative relative frequency or can be extracted as a maximum count value with this respective percentage from the distribution of the cumulative relative frequencies.

In the operating phase of the optical sensor, the operating signals can be validated and marked based on whether they are, for example, above one, two, three or all of the signal threshold values that are associated with the current background level during the operating phase. This can enable a flexible further processing of output signals of the optical sensor if, for example, algorithms that further process the output signals of the optical sensor require a differently pronounced filtering with respect to false-positive output signals.

The processing unit can further be configured, during the calibration phase of the optical sensor, to create the calibration data set in the form of at least one look-up table in which the respective signal threshold values and the associated background levels are contained. In other words, the result of the calibration phase can be presented as a look-up table that can be directly used to assess the current operating measurement signals during the operating phase of the optical sensor. If a plurality of percentages for false-positive output signals are predefined to determine respective sets of signal threshold values for the associated background levels, the control and evaluation unit can create a plurality of look-up tables during the calibration phase, i.e. a respective look-up table for each of the predefined percentages. The representation of the signal threshold values by means of at least one look-up table can require little computer-related effort, for example little memory space and an uncomplicated computational processing.

The processing unit can additionally be configured to approximate the look-up table using an analytical function. The computer-related effort during the operating phase of the optical sensor can thereby be further reduced to filter out the invalid output signals from the operating measurement signals. The analytical function can comprise or more parameters to approximate the look-up table and can be represented as a polynomial or a Laurent series, for example. The approximation of the look-up table by means of the analytical function can in particular be relevant if a large number of possible background levels are considered, whereby the necessary memory requirement for the at least one look-up table and its processing time can increase. Using the approximated analytical function, the information obtained during the calibration phase can be stored in compressed form with respect to the signal threshold values.

According to a further embodiment, the optical sensor can be configured as a lidar sensor with time-correlated single photon counting (TCSPC). In this embodiment, the transmission unit can comprise a laser that emits short light pulses into the environment of the optical sensor and that can scan this environment as a scanning laser in so doing. The TCSPC histograms, which are produced in such a lidar sensor by means of the control and evaluation unit, comprise the aforementioned distance bins that correspond to a respective time-of-flight interval for the light pulses emitted by the laser of the lidar sensor. In other words, the TCSPC histograms of such a lidar sensor can comprise respective count values per distance bin.

For this embodiment, the processing unit can further be configured, in the calibration phase of the lidar sensor, to determine a respective set of signal threshold values for a plurality of distance ranges within a range of the lidar sensor. The respective sets of signal threshold values for the mutually different plurality of distance ranges can be due to the fact that the lidar sensor with time-correlated single photon counting has a distance-dependent noise characteristic. The noise and the corresponding background level can thus have different values for different distances from objects at which the light pulses of the lidar sensor can be reflected. It can therefore be useful to divide the range of the lidar sensor into a plurality of distance ranges or groups of distance bins disposed next to one another and to determine a respective set of signal threshold values for them. These multiple sets of signal threshold values can then be displayed in a two-dimensional look-up table and stored in a memory of the optical sensor for use during its operating phase.

According to a further embodiment, the reception unit of the optical sensor can comprise a plurality of groups of pixels that each have different characteristics with respect to the noise. In this case, the processing unit can further be configured, in the calibration phase of the optical sensor, to determine a respective set of signal threshold values for each of these groups of pixels.

For this purpose, during the calibration phase of the optical sensor, the processing unit can control the illumination unit of the calibration device when the transmission unit of the optical sensor is deactivated such that the illumination unit illuminates the reception unit with a plurality of predetermined light intensities and, for each predetermined light intensity, calibration measurement signals of the reception unit of the optical sensor are acquired for each group of pixels in order to determine a respective signal threshold value per pixel group based on the respective calibration measurement signals and to assign one of the background levels for the optical sensor to the respective signal threshold value per pixel group.

The result of such a calibration phase, i.e. the respective sets of signal threshold values per pixel group, can in turn be produced as a two-dimensional look-up table and can be stored as a calibration data set in a memory of the optical sensor. In extreme cases, the calibration can take place per pixel, i.e., in such a case, each group of pixels can comprise only a single pixel.

According to a further embodiment, the control and evaluation unit can further be configured, during the operating phase of the optical sensor, to determine the current background level as a mean value or median over at least a predetermined proportion of the operating measurement signals. If the optical sensor is configured as a sensor with time-correlated single photon counting, the mean value can be determined over an entire TCSPC histogram that is recorded during the operating phase of the optical sensor. Based on such a mean value, the current background level can be determined with little effort. Alternatively, the current background level can also be determined in another way, for example by a separate detection of environmental light when the transmission unit is briefly deactivated.

A further subject of the invention is a sensor system that comprises an optical sensor, as described above, and a calibration device. The calibration device is in communication with the optical sensor during a calibration phase of the optical sensor and is configured to generate a calibration data set for the optical sensor. The calibration data set comprises a plurality of signal threshold values that are associated with a respective background level that corresponds to a respective predetermined light intensity.

The sensor system thus comprises the optical sensor described above and the calibration device likewise described above. The statements regarding the optical sensor and the calibration device thus apply accordingly to the sensor system; this in particular applies with respect to advantages and preferred embodiments.

A further subject of the invention is a method of calibrating an optical sensor that has a transmission unit and a reception unit and that is in communication with a calibration device during a calibration phase. The method comprises that a light intensity of an illumination unit of the calibration device is varied, for example when the transmission unit of the optical sensor is deactivated, such that the reception unit is illuminated with a plurality of predetermined light intensities. Calibration measurement signals of the reception unit are acquired for each predetermined light intensity, a respective signal threshold value is determined based on the calibration measurement signals and the respective signal threshold value is associated with a background level for the optical sensor, which background level corresponds to the respective predetermined light intensity. The signal threshold values are provided as a calibration data set for an operating phase of the optical sensor when the transmission unit is activated so that, during the operating phase, a control and evaluation unit of the optical sensor is able to select one of the signal threshold values of the calibration data set based on a current background level, which is determined based on operating measurement signals that are acquired by means of the reception unit of the optical sensor during the operating phase, and to identify output signals that are derived from the operating measurement signals when the transmission unit is activated as an invalid signal if the respective output signal is smaller than the selected signal threshold value.

The method can be performed by means of the above-described sensor system. The statements regarding the sensor system, the optical sensor and the calibration device thus apply accordingly to the method; this in particular applies with respect to advantages and preferred embodiments. It is furthermore understood that all the features mentioned herein can be combined with one another, unless explicitly stated otherwise.

As explained above, the current background level during the operating phase can be determined either directly based on measurement signals when the transmission unit of the optical sensor is activated or in that, immediately after a respective measurement when the transmission unit is activated, in each case a second measurement when the transmission unit is deactivated takes place and determines the current background level. In both cases, the current background level is thus determined based on operating measurement signals that are acquired during the operating phase.

According to one embodiment of the method, the optical sensor is configured for a time-correlated single photon counting (TCSPC). Respective histograms of the time-correlated single photon counting (TCSPC histograms) can be produced for both the calibration measurement signals and the operating measurement signals.

A respective plurality of TCSPC histograms can be produced for the calibration measurement signals at each predetermined light intensity. For each of these TCSPC histograms that are associated with the respective predetermined light intensity, a respective maximum count value can be determined in order to determine a statistical distribution of the maximum count values for the respective predetermined light intensity. Based on the statistical distribution, a respective cumulative relative frequency of the maximum count values can further be determined for each predetermined light intensity. The respective signal threshold values for the predetermined light intensities can further be determined based on the respective cumulative relative frequency.

The invention will be described below by way of example with reference to an advantageous embodiment and to the enclosed Figures. There are shown, schematically in each case:

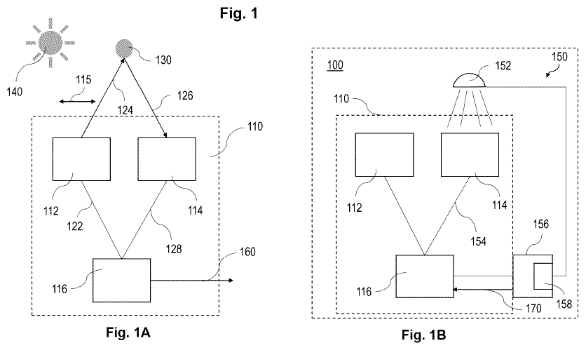

FIG. 1 an optical sensor according to the invention in an operating phase and in a calibration phase;

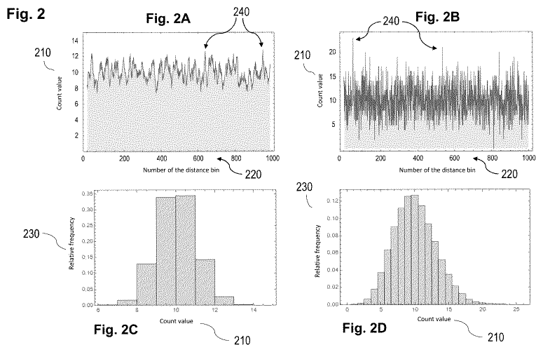

FIG. 2 two different scenarios in which a virtually identical background level, but different noise characteristics of the optical sensor are present; and

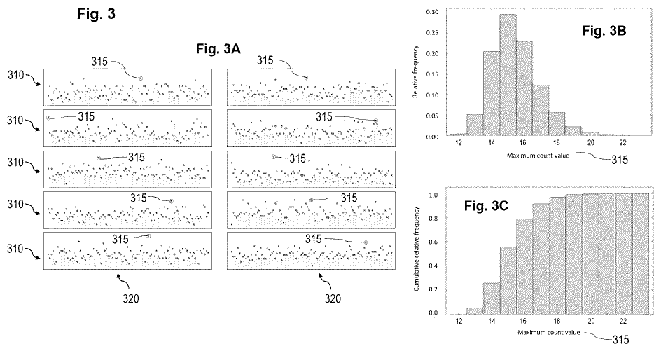

FIG. 3 a plurality of diagrams that illustrate the calibration phase of the sensor system.

FIG. 1 shows a schematic representation of an optical sensor 110. The optical sensor 110 is shown in FIG. 1A in an operating phase and in FIG. 1B in a calibration phase in which the optical sensor 100 is integrated into a sensor system 100 that additionally comprises a calibration device 150.

The optical sensor 110 is configured as a lidar sensor that uses the measurement principle of a time-correlated single photon counting (TCSPC). The optical sensor or lidar sensor 110 therefore comprises a transmission unit 112 comprising a laser that periodically transmits light pulses into the environment of the lidar sensor 110. The periodic light pulses of the laser of the transmission unit 112 are schematically shown in FIG. 1A as a transmission signal 124. The periodic light pulses are a few nanoseconds long, i.e. shorter than 10 ns, for example, and define a starting point in time of a respective measurement of the lidar sensor 110.

The lidar sensor 110 further comprises a reception unit 114 that is provided with an array comprising a plurality of pixels. The reception unit 114 detects those light pulses 124 which are reflected or scattered back at an object 130 in the environment of the lidar sensor 110 and, accordingly, are incident on one of the pixels of the reception unit 114 as reflected or scattered-back light pulses 126. The lidar sensor 110 furthermore comprises a control and evaluation unit 116 that controls the transmission unit 112 and its laser by means of control signals 122 and moreover acquires operating measurement signals 128 from the reception unit 114. The evaluation unit 116 derives output signals 160 of the lidar sensor 110 from the operating measurement signals 128, as explained in detail below.

The transmission unit 112 of the lidar sensor 110 is further provided to deflect the emitted laser beam or the transmission signal 124 such that the transmission signal 124 sweeps over a certain spatial region and samples it. For this purpose, the control and evaluation unit 116 outputs a corresponding control signal that is contained in the control signals 122 and that is received by the transmission unit 112. The deflection of the transmission signal 124 and the corresponding sampling of a spatial region are schematically shown in FIG. 1A by the arrow 115.

The time interval between two light pulses which are emitted by the laser of the transmission unit 112 can be divided into a plurality of short time sections that are each 500 ps long, for example. Furthermore, each of these time sections can be assigned a point in time that corresponds to a time interval from the starting point in time of the respective measurement at which the last light pulse was emitted by the laser of the transmission unit 112.

Depending on the distance of the object 130 relative to the lidar sensor 110, the reflected or scattered-back light pulse 126 reaches the reception unit 114 of the lidar sensor 110 at different points in time since the light pulses 124, 126 have different times of flight depending on the distance of the object 130 from the starting point in time of the measurement until the detection in the reception unit 114. On the respective detection of a reflected or scattered-back light pulse 126, the pixels of the reception unit 114 generate an electrical signal as the respective operating measurement signal 128 that is associated with one of the time sections within the time interval between two light pulses by means of a time-to-digital converter (TDC) in the control and evaluation unit 116.

In the operating phase of the optical sensor or lidar sensor 110, the transmission unit 112 emits a plurality of light pulses by means of its laser so that the corresponding electrical signals or events that are generated by reflected or scattered-back light pulses 126 in the reception unit 114 and that are associated with a respective time section between two light pulses are counted for this plurality of emitted light pulses 124. The association of the counted electrical signals or events that are output as an operating measurement signal 128 by the reception unit 114 and detected by the control and evaluation unit 116 takes place in the control and evaluation unit 116 such that the respective count value per time section is displayed internally in the form of a histogram of the time-correlated single photon counting (TCSPC histogram).

Since the time sections of the TCSPC histogram correspond to different times of flight of the light pulses up to the object 130 and back to the lidar sensor 110 and thus to different distances relative to the lidar sensor 110, respective distances relative to the lidar sensor 110 can be associated with the respective time sections into which the time interval between two light pulses of the laser of the transmission unit 112 is divided. Since the different times of flight of the light pulses 124, 126 can thus be converted into corresponding distances and the time sections correspond to respective distances, the count values of the TCSPC histogram are usually plotted for respective so-called distance bins that each cover a corresponding distance interval that corresponds to a respective time-of-flight interval of the light pulses 124, 126.

Two examples of TCSPC histograms are shown schematically in the two upper diagrams of FIG. 2 that are designated as FIG. 2A and FIG. 2B. In the two TCSPC histograms of FIG. 2A and FIG. 2B, respective count values 210 are shown on the y-axis above a plurality of distance bins 220 on the x-axis. Both histograms of FIGS. 2A and 2B show a background level or an average noise value that is approximately 10 for both histograms. The background level exists due to the environmental conditions of the lidar sensor 110, for example, due to extraneous light that is emitted by an extraneous light source 140 (cf. FIG. 1) and that is detected by the pixels of the reception unit 114. The background level is consequently a specific count value 210 which is valid for all the distance bins and with which a specific intensity of the extraneous light is associated.

The histograms of FIG. 2A and FIG. 2B represent two different scenarios in which different internal properties or configurations of the optical sensor 110 lead to very different noise characteristics. With the same background level or average noise value, the two histograms of FIG. 2A and FIG. 2B therefore exhibit very different noise, i.e. in each case very different fluctuations relative to the background level or the average noise value. As will be explained in detail below, it is therefore difficult to different degrees for the histograms of FIG. 2A and FIG. 2B to decide whether a specific count value 210 is produced by a reflection at an object and is thus a true-positive echo or whether this count value 210 is produced by extraneous light and therefore represents a false-positive echo that should be filtered out or should be marked in the output signal 160 (cf. FIG. 1).

This is also reflected in the two bottom diagrams of FIG. 2 which are designated as FIGS. 2C and 2D and in which respective relative frequencies 230 are plotted on the y-axis above the respective count values 210 on the x-axis. FIG. 2C thus represents the relative frequencies of the count values 210 for the histogram of FIG. 2A, whereas FIG. 2D represents the respective relative frequencies for the count values 210 of FIG. 2B.

The distributions of the count values 210 in the representations of FIGS. 2C and 2D, respectively, each have approximately the same maximum value at approximately 10, corresponding to the background level or average noise value of FIGS. 2A and 2B. Corresponding to the very different noise in the histograms of FIGS. 2A and 2B, the two distributions of FIGS. 2C and 2D, however, have a very different width.

If TCSPC histograms are evaluated to identify objects 130 and to determine their distance relative to the lidar sensor 110, it must be possible to distinguish whether a specific count value of a distance bin actually originates from a light pulse 124, 126 that is emitted by the laser of the transmission unit 112 and that was reflected or scattered back as a light pulse 126 at an object 130, or whether the corresponding count value of the distance bin is merely caused by another event such as extraneous light. The quality of the evaluation depends heavily on the signal-to-noise ratio in the respective histograms, as is illustrated in FIGS. 2A and 2B.

In both histograms, the two distance bins with the largest count values are each marked with 240 and represent possible output signals 160 of the lidar sensor 110 (cf. FIG. 1). Due to the noise and the relatively high background level, in both histograms of FIGS. 2A and 2B, it is not easy to decide whether the count values at 240 actually originated as an echo of a light pulse 124 at an object 130 or not. When evaluating the histograms, however, it must be possible to determine whether, for example, the count values at 240 are true output signals 160 (cf. FIG. 1) or true-positive output signals 160 or invalid output signals 160 or false-positive output signals 160. The aim of the evaluation of such histograms of FIG. 2A and FIG. 2B is to achieve the smallest possible proportion of false-positive output signals 160, for example 1%, that are not identified and are filtered out. This means that, on average, only one false-positive output signal 160 is contained in one hundred output signals 160 that are ultimately output by the control and evaluation unit 116 (cf. FIG. 1).

In known evaluation methods, a suitably assumed distance dimension of a count value 210 relative to the respective mean value of the histogram is usually used to decide whether the respective count value 210 is false-positive or true-positive. A multiple of the standard deviation relative to the respective mean value or to the background level or a Mahalanobis distance relative to the background level is usually used as such a distance dimension. However, the use of the standard deviation or the Mahalanobis distance relative to the mean value requires the assumption that the distribution of the count values satisfies a specific model or a specific distribution, for example a Poisson distribution, a binomial distribution or a normal distribution.

However, as can be recognized in the diagrams of FIGS. 2C and 2D, the distributions of the relative frequencies 230 for the count values are indeed similar to a normal distribution, but not exactly symmetrical. Consequently, an analytical description of these distributions, for example by means of a normal distribution, can be subject to errors. The use of a multiple of the standard deviation, which ultimately requires a normal distribution, can furthermore lead to a differently effective filtering of the count values in the histograms at different background levels since the approximation to a normal distribution can be differently effective depending on the respective background level. This has the result that a so-called false-positive rate (FPR), i.e. the proportion of non-recognized false-positive output signals 160, can vary greatly for different background levels.

This problem can be illustrated by the diagrams in FIG. 2. For example, if a count value of 15 were to be determined as one of the maximum values in the histograms of FIG. 2A and FIG. 2B, the control and evaluation unit 116 should be able to automatically decide whether this count value originates from a real object 130 or not. In the example of FIGS. 2A and 2C, such a value of 15 is already in an outlier or, so to speak, outside the distribution of the relative frequencies 230, while this value for the histogram of FIG. 2B and the distribution of FIG. 2D is still at a relative frequency within the statistical distribution, i.e. not yet far enough in an outlier of the distribution. In the example of FIGS. 2A and 2C, it is consequently relatively likely that a count value of 15 originates from a real object 130 and is thus a true-positive output signal 160, whereas such a value for the example of FIGS. 2B and 2D is to be viewed as a false-positive output signal 160 with a relatively high probability.

The sensor system 100 shown in FIG. 1B and a corresponding calibration method are therefore provided for a calibration phase of the optical sensor or lidar sensor 110. In the calibration phase, a calibration data set 170 is generated for the control and evaluation unit 116 of the optical sensor 110. By means of the calibration data set 170, the control and evaluation unit 116 is able to filter the signals of the lidar sensor 110 or the TCSPC histograms with respect to false-positive output signals 160 such that an assumption, for example with respect to a specific distribution relative to a mean value, such as a normal distribution, is not required. Furthermore, an almost constant false-positive rate can be predefined independently of the respective background level or the environmental conditions of the lidar sensor 110.

The sensor system 100 therefore comprises, in addition to the lidar sensor 110, a calibration device 150 (cf. FIG. 1B) that is connected to the lidar sensor 110 during the calibration phase. As schematically shown in FIG. 1B, the transmission unit 112 of the optical sensor or lidar sensor 110 is deactivated during the calibration phase. Instead, the reception unit 114 is illuminated by an illumination unit 152 of the calibration device 150 that provides a plurality of predetermined light intensities during the calibration phase.

The illumination unit 152 can either be an external light source that generates the various predetermined light intensities itself. However, the illumination unit 152 can also merely modulate or shade a constant light intensity of an external light source, such as of the extraneous light source 140 (cf. FIG. 1A), to thereby generate the various predetermined light intensities for the reception unit 114. For example, the illumination unit 152 can merely shade the sunlight so that said illumination unit does not have its own light source.

Despite the laser of the transmission unit 112 being deactivated, the reception unit 114 outputs calibration measurement signals 154 in the calibration phase that are caused by the respective light intensities provided by the illumination unit 152. The control and evaluation unit 116 of the lidar sensor 110 acquires the calibration measurement signals 154 for the respective predetermined light intensities of the illumination unit 152 and produces corresponding TCSPC histograms just like in the operating phase of the lidar sensor 110 shown in FIG. 1A.

A processing unit 156 of the calibration device 150 is communicatively connected to the control and evaluation unit 116 of the lidar sensor 110. In the calibration phase of the lidar sensor 110, the processing unit 156 receives the TCSPC histograms that are produced by the control and evaluation unit 116 based on the calibration signals 154 and evaluates them, as described below, to thereby generate the calibration data set 170 that is used by the lidar sensor 110 in the operating phase. At the end of the calibration phase, the processing unit 156 transmits the calibration data set 170 to the control and evaluation unit 116 that stores the calibration data set 170 so that it is available during the operating phase of the lidar sensor 110.

The processing unit 156 is indeed shown in FIG. 1B as part of the calibration device 150 outside the lidar sensor 110. Nevertheless, the processing unit 156 can also be integrated into the control and evaluation unit 116 and can thus be a component of the lidar sensor 110. In this case, the processing unit 156 within the control and evaluation unit 116 is only activated when the lidar sensor 110 is in the calibration phase.

The processing unit 156 comprises a control module 158 that is in communication with the illumination unit 152 to control the respective light intensity with which the illumination unit 152 illuminates the reception unit 114 of the lidar sensor 110. The control module 158 therefore predefines a respective light intensity of the illumination unit 152 and thus a corresponding background level. For these, the reception unit 114 generates the respective calibration measurement signals 154 based on which the control and evaluation unit 116 in turn generates corresponding TCSPC histograms (cf. FIG. 3). The processing unit 156 then uses said TCSPC histograms to determine the respective signal threshold value that is associated with the background level as an element of the calibration data set 170.

The predetermined, variable light intensities of the illumination device 152 thus each correspond to background levels of the respective histograms that are to be expected during the operating phase of the lidar sensor 110. For each predetermined light intensity, which thus corresponds to a specific background level to be expected, the control and evaluation unit 116 produces a plurality of histograms so that sufficient statistics are available during the calibration phase.

Ten such histograms (cf. FIG. 3A) are shown by way of example in FIG. 3 for a specific background level together with the corresponding statistical evaluation (cf. FIGS. 3B and 3C). In the histograms, as in the diagrams of FIGS. 2A and 2C, count values 310 are plotted over respective distance bins 320, but for the calibration phase when the transmission unit 112 of the lidar sensor 110 is deactivated. The histograms of FIG. 3A represent only one of the background levels with the associated noise of the calibration signals 154 when the transmission unit 112 is deactivated.

For each of the histograms of FIG. 3A, which are produced during the calibration phase of the lidar sensor 110 for a predefined background level, a respective maximum count value 315 is determined by means of the processing unit 156 and is marked in the respective histograms. The maxima 315 are used to determine a distribution of their relative frequencies, as is shown in FIG. 3B. The respective relative frequency (on the y-axis) for the maximum count values from the histograms of FIG. 3A (on the x-axis) is thus shown in FIG. 3B. Based on the relative frequencies of FIG. 3B, a distribution of the cumulative relative frequencies is then determined that is shown in FIG. 3C in dependence on the maximum count value 315. As is to be expected, the cumulative relative frequency approaches the value of 1.0 with increasing count values.

Since the underlying calibration measurement signal 154 of the histograms of FIG. 3A was only generated by the illumination unit 152 to simulate a specific background level with noise, a specific value of the cumulative relative frequency in FIG. 3C that is associated with a specific count value corresponds to a probability with which all count values smaller than this specific count value in the operating phase of the lidar sensor 110 are false-positive count values that are only caused by the background level and the noise. Conversely, a specific probability or cumulative relative frequency can, based on the representation of the cumulative relative frequencies of FIG. 3C, be directly assigned a specific maximum count value from which all smaller count values with this probability are recognized as false-positive count values in the operating phase.

For example, for a specific count value of 20 that is associated with a cumulative relative frequency of 0.99 in FIG. 3C, the probability that a false-positive output signal 160 will not be recognized is only 1% since the remaining cumulative relative frequency of all larger count values is only 0.01. In other words, a count value of 20 in the operating phase of the lidar sensor 110 for the corresponding background level with a probability of 1% is a false-positive output signal 160 or an invalid output signal 160, whereas the count value of 20 with a probability of 99% is a true-positive or a valid output signal 160.

Therefore, in the calibration phase of the lidar sensor 110, a specific value for the false-positive rate or probability for the occurrence of a false-positive output signal 160 is initially predefined, for example 1%. Based on the cumulative relative frequency of FIG. 3C, a count value is then determined at a cumulative relative frequency that is complementary to the predefined probability, i.e. for the present example at the cumulative relative frequency of 0.99. This count value is used in the operating phase as a signal threshold value for the background level under consideration that is simulated by a predetermined light intensity of the illumination unit 152. The respective signal threshold value, together with the associated background level, forms an element of the calibration data set 170 (cf. FIG. 1) that is produced by the processing unit 156 in order to be transmitted by it to the control and evaluation unit 116 of the lidar sensor 110 and stored there. It is ensured by the respective signal threshold value that, for the present example, 99% of the false-positive count values in the output signal 160 are recognized or filtered out in the operating phase at the background level under consideration and only 1% of non-recognized false-positive count values are to be expected.

During the calibration phase of the lidar sensor 110, all the background levels relevant to the operating phase of the lidar sensor 110 are first determined and are associated with corresponding predetermined light intensities that are to be provided by the illumination unit 152. The histograms of FIG. 3A and the distributions of the relative and cumulative frequencies of FIG. 3B and FIG. 3C are then determined for each relevant background level and each predetermined light intensity, respectively, so that the processing unit can create the calibration data set 170.

Based on the respective cumulative relative frequencies (cf. FIG. 3C), a specific count value is then determined as a signal threshold value for each relevant background level and corresponds to the predefined probability or false-positive rate of 1%, for example. Thus, each relevant background level for the lidar sensor 110 is assigned a specific signal threshold value in the form of a specific count value. Finally, the respective value pairs of the background level and signal threshold value are stored in a look-up table that is provided for the operating phase of the lidar sensor 110 and thus represents the calibration data set 170. Consequently, during the operating phase of the lidar sensor 110, the count value in a TCSPC histogram must reach at least the signal threshold value for a specific background level in order to be identified as a valid output signal 160 (cf. FIG. 1A) of the lidar sensor 110.

During the operating phase of the optical sensor or lidar sensor 110, operating measurement signals 128 (cf. FIG. 1A) are acquired after the calibration phase by means of the reception unit 114 when the transmission unit 112 is activated and the illumination unit 152 is deactivated or not present during the operating phase, and a similar TCSPC histogram to those histograms shown in FIGS. 2A and 2C is produced for the operating measurement signals 128. Based on this TCSPC histogram, a current background level is then determined, for example as a mean value or median over the histogram, to assign one of the signal threshold values from the calibration phase of the lidar sensor 110 to this current background level. The respective count values from the TCSPC histogram are then identified as an invalid or false-positive signal if the count value is smaller than the signal threshold value that is associated with the current background level or has been selected for it. Conversely, only those count values of the TCSPC histogram together with the corresponding value of the distance bin for which the count value is greater than or equal to the signal threshold value for the current background level are output as a valid output signal 160 of the lidar sensor 110.

Reference numeral list

| | |
|---|---|
| 100 | sensor system |
| 110 | optical sensor, lidar sensor |
| 112 | transmission unit |
| 114 | reception unit |
| 43 | scanning zone |
| 116 | control and evaluation unit |
| 122 | control signal |
| 124 | transmission signal |
| 126 | reception signal |
| 128 | operating measurement signal |
| 130 | object |
| 140 | extraneous light source |
| 150 | calibration device |
| 152 | illumination unit |
| 154 | calibration measurement signal |
| 156 | processing unit |
| 158 | control module |
| 160 | output signal |
| 170 | calibration data set |
| 210 | count value |
| 220 | distance bin |
| 230 | relative frequency |
| 240 | maximum count values, identified echoes |
| 310 | count value |
| 315 | maximum count value per histogram |
| 320 | distance bin |

1. An optical sensor, comprising:
a transmission unit for emitting an optical transmission signal into the environment of the optical sensor,
a reception unit that is configured to detect a reflected or remitted portion of the transmission signal, and
a control and evaluation unit that is configured:
to receive and store a calibration data set before an operating phase of the optical sensor,
wherein the calibration data set comprises a plurality of signal threshold values that are associated with a respective background level that corresponds to a respective predetermined light intensity,
during the operating phase of the optical sensor:
to receive operating measurement signals from the reception unit when the transmission unit is activated,
to determine a current background level and to select one of the signal threshold values of the calibration data set based on the current background level, and
to identify output signals that are derived from the operating measurement signals as an invalid signal if the respective output signal is smaller than the selected signal threshold value.

2. The optical sensor according to claim 1, wherein
the optical sensor is configured to be in communication with a calibration device during a calibration phase before the operating phase, said calibration device having an illumination unit that illuminates the reception unit (114) with the respective predetermined light intensity to which the respective background level corresponds, and
the control and evaluation unit is further configured, during the calibration phase, to detect calibration measurement signals of the reception unit for each predetermined light intensity so that a processing unit is able to generate the calibration data set based on the calibration measurement signals.

3. The optical sensor according to claim 2, wherein
the optical sensor is configured for a time-correlated single photon counting, and
the control and evaluation unit is configured to produce respective histograms of the time-correlated single photon counting for both the calibration measurement signals and the operating measurement signals.

4. The optical sensor according to claim 3, wherein
the control and evaluation unit is further configured, during the calibration phase of the optical sensor, to produce a respective plurality of TCSPC histograms for each predetermined light intensity, and
the processing unit is configured, during the calibration phase of the optical sensor, to determine a respective maximum count value for each of the TCSPC histograms that are associated with the respective predetermined light intensity in order to produce a statistical distribution of the maximum count values for the respective predetermined light intensity, and to determine the signal threshold values for the respective predetermined light intensities based on the statistical distribution.

5. The optical sensor according to claim 4, wherein
the processing unit is further configured, during the calibration phase of the optical sensor (110):
to determine a respective cumulative relative frequency of the maximum count values for each predetermined light intensity based on the statistical distribution, and
to determine the respective signal threshold values for the predetermined light intensities based on the respective cumulative relative frequency.

6. The optical sensor according to claim 5, wherein
the processing unit is further configured, during the calibration phase of the optical sensor, to use at least one predefined percentage for false-positive output signals in order to determine the respective signal threshold values for the associated background level based on the respective cumulative relative frequency.

7. The optical sensor according to claim 5, wherein
the processing unit is further configured, during the calibration phase of the optical sensor, to use a plurality of predefined percentages for false-positive output signals in order to determine, for each predefined percentage, a set of respective signal threshold values for the associated background level based on the respective cumulative relative frequency.

8. The optical sensor according to claim 2, wherein
the processing unit is further configured, during the calibration phase of the optical sensor, to produce the calibration data set in the form of at least one look-up table in which the respective signal threshold values and the associated background levels are contained.

9. The optical sensor according to claim 2, wherein
the optical sensor is configured as a lidar sensor with time-correlated single photon counting.

10. The optical sensor according to claim 9, wherein
the processing unit is further configured, in the calibration phase of the lidar sensor, to determine a respective set of signal threshold values for a plurality of distance ranges within a range of the lidar sensor (110).

11. The optical sensor according to claim 2, wherein
the reception unit of the optical sensor comprises a plurality of groups of pixels,
the groups of pixels each have different characteristics with respect to the noise, and
the processing unit is further configured to determine a respective set of signal threshold values for each group of pixels in the calibration phase of the optical sensor.

12. A sensor system comprising:
an optical sensor according to claim 1; and
a calibration device that is in communication with the optical sensor during a calibration phase of the optical sensor and that is configured to generate a calibration data set for the optical sensor,
wherein the calibration data set comprises a plurality of signal threshold values that are associated with a respective background level that corresponds to a respective predetermined light intensity.

13. A method of calibrating an optical sensor that has a transmission unit and a reception unit and that is in communication with a calibration device during a calibration phase, wherein the method comprises that:
a light intensity of an illumination unit of the calibration device of the optical sensor is varied such that the reception unit is illuminated with a plurality of predetermined light intensities,
calibration measurement signals of the reception unit are acquired for each predetermined light intensity, a respective signal threshold value is determined based on the calibration measurement signals, and the respective signal threshold value is associated with a background level for the optical sensor, which background level corresponds to the respective predetermined light intensity, and
the signal threshold values for an operating phase of the optical sensor when the transmission unit is activated are provided as a calibration data set so that, during the operating phase, a control and evaluation unit of the optical sensor is able:
to select one of the signal threshold values of the calibration data set based on a current background level that is determined based on operating measurement signals that are acquired by means of the reception unit of the optical sensor during the operating phase, and
to identify output signals that are derived from the operating measurement signals when the transmission unit is activated as an invalid signal if the respective output signal is smaller than the selected signal threshold value.

14. The method according to claim 13, wherein
the optical sensor is configured for a time-correlated single photon counting,
respective histograms of the time-correlated single photon counting are produced for both the calibration measurement signals and the operating measurement signals.

15. The method according to claim 14, wherein
a respective plurality of TCSPC histograms are produced for the calibration measurement signals at each predetermined light intensity,
a respective maximum count value is determined for each of the TCSPC histograms that are associated with the respective predetermined light intensity in order to produce a statistical distribution of the maximum count values for the respective predetermined light intensity,
a respective cumulative relative frequency of the maximum count values is determined for each predetermined light intensity based on the statistical distribution, and
the respective signal threshold values for the predetermined light intensities are determined based on the respective cumulative relative frequency.
